(19) United States
(12) Patent Application Publication
(10) Pub. No.: US 2016/0040890 A1
(43) Pub. Date: Feb. 11, 2016

(54) PORTABLE COOKING STOVE

(71) Applicant: STANDARD BRANDS (UK) LIMITED, Leatherhead, Surrey (GB)

(72) Inventor: Eric Dennis Barford, Faro (PT)

(21) Appl. No.: 14/782,864

(22) PCT Filed: Apr. 8, 2013
(86) PCT No.: PCT/GB2013/000156

§ 371 Date: Oct. 7, 2015

(51) Int. Cl. F24B 1/20; A47J 33/00

(52) U.S. Cl. CPC F24B 1/205; A47J 33/00

(57) ABSTRACT

This invention relates to cooking stoves and in particular, to lightweight, efficient and portable outdoor cooking stoves. The cooking stoves are primarily for military use, for example by the dismounted infantry soldier, but are also suitable for other outdoor leisure pursuits such as backpacking, hiking and boating. The cooking stoves are designed to make efficient use of pre-packaged fuel blocks, to withstand cold temperatures and high winds, to protect combustible surroundings and to mask flames from an enemy.

### FIELD OF INVENTION

This invention relates to cooking stoves and in particular, to lightweight, efficient and portable outdoor cooking stoves. The cooking stoves are primarily for military use, for example by the dismounted infantry soldier, but are also suitable for other outdoor leisure pursuits such as backpacking, hiking and boating. The cooking stoves are designed to make efficient use of pre-packaged fuel blocks, to withstand cold temperatures and high winds, to protect combustible surroundings and to mask flames from an enemy.

### BACKGROUND TO THE INVENTION

Military forces and outdoor enthusiasts that carry their own equipment, often for extended periods of time, need their equipment to be lightweight (under 500 grams) and suitable for compact storage. Pre-packaged solid fuel blocks can be used, such as hexamine blocks, trioxane blocks or solidified methyl decanoate blocks. These blocks prevent the need for extra containers (as with gas or liquid fuels) or regulation equipment (pressure regulators or valves) and reduce the risk of fuel spillage or other accidental release. Certain solid fuels are waterproof, and further waterproof protection can be provided by means of a thin plastic wrapper. The flames from fuel blocks, however, can be large and as such significant amounts of combustion occurs in flames that are not underneath the cooking vessel. This heat is lost, requiring the operator to carry large amounts of fuel to compensate for this loss.

Cooking stoves do not just provide for the luxury of heated food and drink. They also provide the critical ability to sterilise water in situations where no sterile water can be found. Typical military criteria require the stove to be able to heat 500 ml of water from near freezing to boiling, and hold boiling for at least five minutes. For heating ready-to-eat pre-packaged meals, the stove must be able to raise a standard meal pack of 500 g in weight to a minimum of 65° C., using just 250 ml of water. It is essential that cooking stoves remain able to meet these specifications repeatedly, throughout many cycles of use, and also remain able to meet these specifications in adverse weather conditions, including cold temperatures and high winds.

The stove should be able to operate in areas where the surroundings are combustible, such as in areas of dry vegetation, without posing a risk of setting fire to the surroundings. This is of particular concern in areas of high wind, where burning fuel or flames may be blown from the stove to the surroundings. Many regulatory authorities prohibit open fires using solid fuels under such conditions and operational military forces would not want to give away their location through a fire.

A further requirement which is important for military use is that no flames should be visible to an enemy. This is a particular problem when designing lightweight cooking stoves, as the taller constructions required to hide taller flames from enemy sight would add excess weight to the stove.

The current standard-issue UK military stove (1) is shown in FIG. 1. It has a rectangular construction that can be collapsed for compact storage. In use, the stove has two solid walls (2, 3) and two substantially open walls (4, 5). This open construction renders the stove susceptible to the wind, poses a risk to combustible surroundings and gives little protection over detection by an enemy. The open construction also causes the stove to lose significant amounts of heat to the surroundings.

The current standard-issue US military stove (6) is a single-piece aluminium construction with a rectangular air inlet (7) and circular vent holes (8) as shown in FIGS. 2, 3 and 4. The kidney-shape of the stove is complementary to the US military cup (9) so that the cup can sit inside the stove in storage as shown in FIG. 3. To use the apparatus, the cup (9) is removed from the stove (6), the stove is inverted, and the cup (9) is placed onto the stove, as shown in FIG. 4. Optionally, the cup (9) can be rotated 180° so that it sits on top of the stove (6) rather than being inserted into the stove.

In the first cooking orientation as shown in FIG. 4, the combustion chamber is small and the flames are not contained below the cooking stove (6). The flames move out of vent holes (8), leading to heat loss and giving a visible signal to enemies. A further reported disadvantage of this arrangement is that the size changes that take place during heating and cooling can seal the stove (6) to the cup (9), making it difficult to disassemble and return to the storage configuration.

In the second orientation where the cup (9) is turned through 180° (not shown), even with the extra volume of an enlarged combustion chamber, the flames still move up the sides of the cup, again leading to heat loss and a visible signal. This also potentially deposits toxic combustion products on regions of the cup that come into contact with the mouth during consumption.

The US military stove (6) is also susceptible to wind, which may extinguish the fuel or blow burning fuel or flames out of the combustion chamber, posing a risk to the surroundings or further serving to alert an enemy. A further disadvantage is that the US military stove may leave characteristic kidney-shaped burn marks on the ground, providing identity and location information to an enemy. Furthermore, contact between the ground and fuel may contaminate the ground, and lead to the fuel block absorbing water, which diminishes its ability to burn well. Remnants of the fuel may also be left behind on the ground posing a toxicity risk to wildlife.

A further portable cooking stove (10) has historically been manufactured by Gould Metal (FIG. 5). The stove has a base (11), and several air entry ports (12). This stove shares the kidney-shaped design with the US military stove. However, due to having a base (11), the cup (not shown) must be stored in the stove (10) in the correct orientation. In this orientation there is no room for a combustion chamber. To use the stove (10), the cup must be removed and supported over the stove, or, alternatively, rotated 180° and reinserted into the stove. In both orientations there are significant gaps surrounding the cup. This means that taller flames will not be contained underneath the cup, leading to heat loss and providing a visible signal. In addition, toxic deposits will be left on portions of the cup that contact the mouth during consumption. Despite having a side which is free from holes, a significant gap is created between the cooking stove and the cup, and the assembly is still susceptible to wind. This may extinguish the fuel or blow burning fuel or flames out of the air inlet ports or out of the top of the stove alongside the sides of the cup.

In view of the disadvantages of existing stoves, it is clear that there remains a need for a stove which can be used outdoors without causing significant fire danger; that can provide for some protection from cold and from high winds, to allow for more efficient heating of the cup and contents; that obscures the flame sufficiently to reduce accidental wild-fire risk and also reduces flame visibility. Such stoves would preferably be light in weight, inexpensive, robust and non-bulky so that they can be readily purchased and easily transported as part of a military or backpacker rucksack or similar.

### SUMMARY OF THE INVENTION

According to a first aspect, the present invention provides a portable cooking stove comprising: a base; a lower section with one or more air inlet ports; an upper section wherein the upper section and/or the lower section is tapered or the upper section is stepped out from the lower section, so that the upper section defines a larger cross sectional area than the lower section, wherein the upper section has one or more exhaust ports; and at least one side of the cooking stove is free from both air inlet ports and exhaust ports.

The two-section stove of the present invention with specifically placed inlet and exhaust ports can provide a surprising increase in heat transfer efficiency from a fuel block to a cooking vessel. As the upper section defines a larger cross sectional area than the lower section, during use a cooking vessel can be supported in the upper section, without extending into the lower section. The lower section can be solely used as a combustion chamber. A cooking vessel can be used which forms an intimate fit with the upper section of the stove. In this way, the problem in prior art stoves of the energy of tall flames not being captured is addressed, since one or more exhaust ports act to restrict airflow thereby decreasing the size of the flame. The flame height is controlled meaning less energy is lost to surroundings. In addition, the burn time is extended meaning there is a longer period for heat to be transferred.

Prior art cooking stoves allow exhaust fumes to vent more freely, generally around the sides of the cooking vessel, resulting in excess loss of heat to the surroundings. In contrast, because the upper section of the stove of the present invention defines a larger cross sectional area than the lower section, it can support and form an intimate fit with a cooking vessel, without the cooking vessel extending into the lower section. The exhaust fumes then generally vent through the exhaust port(s) only. Furthermore, using the exhaust port(s) of the present invention keeps toxic deposits of the exhaust fumes away from parts of the cooking vessel that contact the mouth on consumption of the vessel contents.

An important feature of the stove of the present invention is that at least one side of the stove is free from air inlet ports or exhaust ports. During use, this allows the cooking stove to be placed in an orientation that protects it from the wind i.e. with the side with no ports facing the wind. This has multiple effects: the fuel is easier to set alight; the fuel is guarded from being extinguished by wind gusts; and the cooking stove is guarded from having burning fuel or flames being blown out of the combustion chamber and posing a fire risk to the surroundings. In many prior art stoves, all orientations of the cooking stove suffer at least one hole or gap that would face a direction susceptible to catching a prevailing wind. Furthermore, the side with no inlet or exhaust ports may be pointed in the direction of an enemy, thereby blocking the visual line-of-sight to the flames by the enemy. The low visibility of the stove is further aided by the reduction in flame height described above.

The cooking stove comprises a base. This base protects the fuel from any damp conditions on the ground. The base also protects the environment from contact with a naked flame, which helps prevent accidental wildfires, helps prevent leaving characteristic evidence of the use of a cooking stove and ensures that toxic remnants of fuel are not left behind. The base further allows the cooking stove to be used while suspended rather than while resting on the ground.

A flame, for example, from a lighter, can be passed into the lower section of the stove though an air inlet port, thereby allowing for the fuel to be set alight when the stove and cooking vessel are assembled. A large advantage provided by the current invention is that the operator benefits from lighting the fuel in a wind-proofed combustion chamber.

In a preferred embodiment of the present invention, the ratio of surface area of the exhaust port or ports to the air inlet port or ports is in the range 0.8:1 to 2:1, preferably 1:1 to 1.5:1. Extensive study by the inventor has revealed that the burn rate of the fuel can be controlled to within desired parameters through the ratio of the surface areas of the exhaust ports to the air inlet ports. The relative surface areas can be tailored to match different fuel compositions. The burn rate can be controlled so that it is fast enough to maintain combustion but slow enough that combustion occurs only in the combustion chamber. As well as helping to reduce flame height, careful selection of port size can ensure that even though combustion is slowed, full combustion still occurs, which prevents loss of unused fuel and prevents the generation of smoke. Preventing incomplete combustion further ensures maximised efficiency in transferring heat to the cooking vessel, and prevents unpleasant smoke that could also act as a visual signal to the enemy. The prior art does not disclose any attempt to control the burn rate of a solid fuel block in a portable stove.

In a preferred embodiment of the present invention, the upper section is stepped out from the lower section by providing an indentation in the lower section which is positioned to block the cooking vessel from entering the combustion chamber. This acts as a method of preventing the cooking vessel from entering too far into the stove, which would result in difficulty separating the cooking vessel from the stove.

According to a second aspect, the present invention provides a kit comprising the cooking stove of the first aspect of the invention and pre-made solid fuel blocks. Examples of suitable fuel blocks are hexamine blocks (e.g. as supplied by ESBIT Gmbh, Germany, trioxane blocks (e.g. as supplied to the USA Military) or solidified methyl decanoate blocks (as supplied by Zip Military Fuels, UK).

According to a third aspect, the present invention provides a kit comprising the cooking stove of the first aspect of the invention and a cooking vessel capable of forming an intimate fit with the upper section of the cooking stove. The cooking vessel is preferably a kidney shaped cup, such as those used in military applications. According to a fourth aspect, the present invention provides a method of heating a cooking vessel using the cooking stove of the first aspect of the invention, wherein the cooking vessel is in intimate contact with the upper section of the cooking stove, a fuel block is inserted into the combustion chamber of the cooking stove, and the fuel block is set alight and allowed to burn.

### BRIEF DESCRIPTION OF THE DRAWINGS

FIG. 1 relates to the prior art and shows current standard-issue UK military stove, without a cooking vessel or fuel, but in the ready for use configuration;

FIG. 2 relates to the prior art and shows current standard-issue US military stove, without a cooking vessel or fuel;

FIG. 3 relates to the prior art and shows the current standard-issue US military stove, with a cup configured for storage;

FIG. 4 relates to the prior art and shows the current standard-issue US military stove, with a cup configured for use;

FIG. 5 relates to the prior art and shows a Gould Metal military stove, without a cooking vessel and without fuel;

FIG. 6 relates to a preferred embodiment of the present invention which can be used where the cooking vessel is a UK military cup, shown without the cooking vessel and without fuel;

FIG. 7 relates to a preferred embodiment of the present invention which can be used where the cooking vessel is a UK military cup, shown without the cooking vessel and without fuel;

FIG. 8 shows a stove according to a preferred embodiment of the present invention, shown with the cooking vessel, which is a UK military cup;

FIGS. 9 to 16 related to experimental results as explained in the Examples.

### DESCRIPTION

The present invention relates to a portable cooking stove. By portable we mean that the stove can easily be carried by one person.

The portable cooking stove of the present invention comprises a base. By base, we mean a solid face. The lower section of the stove extends from the base to form, during use, a combustion chamber. Accordingly, during use fuel is supported on top of the base. The base protects the ground from being damaged or contaminated by the burning fuel, and protects the fuel from any water in or on the ground. Optionally, the base may be perforated, wherein the perforated regions of the base are raised so as to not contact the ground. Preferably the base is blank, i.e. is not perforated. The base allows for the cooking stove to be placed on multiple surfaces or even to operate while suspended above the ground.

The portable cooking stove of the present invention additionally comprises a lower section and an upper section. The upper section extends from the lower section, which itself extends from the base. The upper section and/or the lower section is tapered or the upper section is stepped out from the lower section, so that the upper section defines a larger cross sectional area than the lower section. The larger cross sectional area means that it is possible, during use, to support a cooking vessel in the upper section, which does not extend into the lower section, thereby leaving the lower section free to act as a combustion chamber. It is preferable that the upper section can form an intimate fit with a cooking vessel, while the lower section is shaped to block entry into the lower section of the cooking vessel. This can be done by providing an indentation in the lower section, or can simply be a result of the lower section having a smaller cross sectional area than the upper section.

By defining a separate lower section and upper section, it is intended that the stove is visibly divided into two parts, through the shape of the construction material. Therefore, where the upper section and the lower section are both tapered, they are not tapered to the same degree, or a step is additionally provided between the upper and lower section to make it clear where the lower section ends and the upper section begins.

The whole stove is preferably made from a single sheet of material. In other words, the portable cooking stove of the present invention is integral. By this we mean that it is one piece. The base, lower and upper sections are joined together and are not detachable.

The lower section of the stove extends from the base. It may extend from the base at 90°, or may be tapered. Where the lower section is tapered, it is generally outwardly tapered at an angle of 90° to 120°. Whether the lower section is tapered or not, the upper section may also be tapered. If the upper section is tapered, it is generally tapered to a small degree, such as 90° to 100°. The tapering is outwards. Tapering of the lower section or the upper section, or differential tapering between the upper and the lower section allows the upper section to define a larger cross sectional area that the lower section. By a larger cross sectional area, we mean that at least a portion of the upper section defines a bigger area, or in other words, has a bigger footprint, than at least a portion of the lower section, preferably the whole of the upper section defines a larger cross sectional area than the whole of the lower section. The cross section is to be taken horizontally, i.e. substantially parallel with the base.

A further possibility for achieving a larger cross sectional area for the upper section, is that the upper section is stepped out from the lower section. In this case, an indentation can be provided in the upper most part of the lower section which is adjacent to the upper section.

Usually the stove of the present invention is around 8 to 20 cm high, and usually 10 to 15 cm high. The lower section is typically comprises less than half the height of the stove, and is usually around 20 to 50% of the height of the stove. The stove is typically 5 to 15 cm wide, usually 10 to 15 cm wide, at it's widest point. These preferred sizes are intended to ensure that the stove fits well with a range of military cups, which typically are designed to hold 500 ml or 1 US pint of water. The lower section, and the base, have a smaller cross sectional area than the upper section. Typically, the surface area of the base is about two thirds of the area of the largest cross sectional area of the upper section.

The purpose of the upper section defining a larger cross sectional area than the lower section, is that the upper section is able to support a cooking vessel, which can sit in the upper section without extending into the lower section. In this way, during use, the lower section of the stove forms a combustion chamber.

The upper section can be shaped to form an intimate fit with a specific cooking vessel. The stove of the present invention is preferably suitable for use with a kidney shaped military style cooking vessel, often referred to as a “cup”. Accordingly, in a preferred embodiment, the upper section of the stove is substantially kidney shaped, and preferably the lower section is also substantially kidney shaped. By kidney shaped we mean having a shape similar to a human kidney, or a kidney bean. This a roughly oval shape, but with one convex side and one concave side.

In a preferred embodiment, the lower section tapers outwardly from the base, and the upper section tapers outwardly from the lower section with a smaller taper angle than the lower section, or the upper section is not tapered. Preferably the upper section is not tapered, so have walls that are substantially parallel.

By intimate fit, we mean that when the cooking vessel is inserted into the cooking stove the size and shape of the cooking vessel is similar to the stove so that the outer perimeter of the cooking vessel is very close to or touches the inner perimeter of the cooking stove, around the majority of the perimeter. Forming an intimate fit means that there are not large gaps between the cooking vessel and the stove, from which exhaust gases can freely leave the stove. Instead, exhaust gases primarily leave the stove through the exhaust ports. In this way, a restriction of airflow through the stove is effectively implemented by the exhaust ports. This restriction of airflow is not provided for by existing stoves.

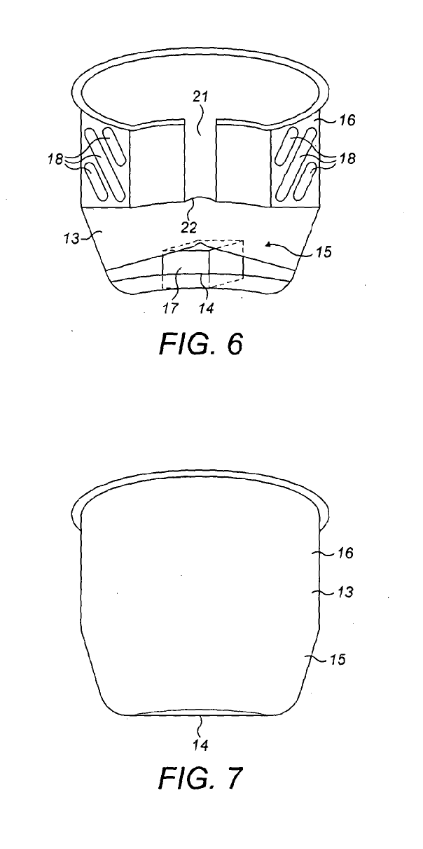

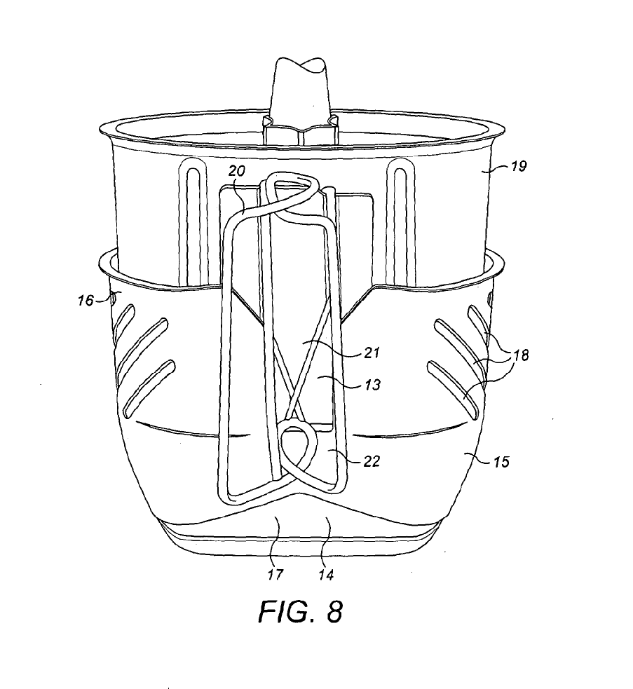

The combustion chamber must have the ability to draw air in from the surroundings. In the present cooking stove air is allowed to enter the combustion chamber through the one or more air inlet ports. Accordingly, the lower section has one or more air inlet ports. The air inlet ports must generally be arranged so that, in the cooking configuration, they allow air to enter the combustion chamber level with, or below, the burning fuel. It is preferred that there is a single inlet port. In a preferred embodiment, the single air inlet port is approximately triangular, as shown in FIGS. 6 and 8. The inlet port is preferably positioned in the lower third of the lower section, with the longest side of the port horizontal to the base.

The upper section has one or more exhaust parts. In use, an intimate fit with a cooking vessel can prevent exhaust gasses and heated air from exiting the stove, except for through exhaust ports. By exhaust port, we mean one or more holes cut into the upper section of the cooking stove to allow exhaust gasses and heated air to leave the stove.

It is preferred that there are multiple exhaust ports, preferably 4 to 8 exhaust ports. In a preferred embodiment, as shown in the figures, there are 6 exhaust ports. The exhaust ports are preferably rectangular slits

From empirical data generated by the inventor, it has been determined that it is important that the ratio of air allowed into the stove, to the freedom for exhaust gases to leave the stove, be tightly controlled. In a preferred embodiment of the present invention, the ratio of surface area of the exhaust port or ports to the air inlet port or ports is in the range 0.8:1 to 2:1, preferably wherein the range is 1:1 to 1.5:1. This is found to be the optimal ratio for good performance of the stove.

When the ratio drops to below about 0.8, too much exhaust gas can accumulate in the combustion chamber resulting in the preclusion of sufficient oxygen entry into the stove. This results in two undesirable consequences, the generation of white smoke from unburnt volatiles, followed by the inability to sustain fuel burn, leading to eventual extinguishing of the flame.

Above a ratio of around 2, the exhaust gases exit too freely resulting in excess flame leaving the exhaust ports. This wastes heat energy, as well as allows for visible luminous flames to be seen at some distance. This could potentially endanger a soldier in a combat situation.

The total surface area of the inlet ports is typically in the range 2,000 to 2,250 mm² The total area of the exhaust ports is typically in the range 1,600 to 4,000 mm².

In the preferred embodiment of the present invention, an additional slot (by this we mean additional to the exhaust ports) is cut into the upper section of the stove. The purpose of this additional slot is to accommodate the handle of a cooking vessel.

Some cooking vessels, such as military cups have a protruding handle that would hinder or prevent insertion into the cooking stove. A slot can be cut into the cooking stove so that when the cooking vessel is inserted with the handle aligned with the slot, a neat fit occurs. Typically, an intimate fit would be maintained in the region around the handle without any opportunity for exhaust gases to escape the stove.

An important feature of the portable cooking stove of the present invention, is that at least one side of the cooking stove is free from both air inlet ports and exhaust ports. By “one side” we mean that if a cross section is drawn vertically through the stove (i.e. perpendicular to the base) to divide it roughly in half, there is always one 180° angle through which the lower and upper sections of the stove can be viewed without seeing any inlet or outlet ports. If the stove was roughly a cube shape, this would mean that at least one face was free of inlet and outlet ports, preferably three faces would be free of inlet and outlet ports. Where the stove is roughly kidney shaped, it is usual to have the inlet and outlet ports on the concave surface of the stove, rather than on the convex surface of the stove.

The portable cooking stove of the present invention can be made from any suitable material. It is usually made from metal, preferably wherein the metal is selected from the group consisting of aluminium, titanium, nickel, copper, or an alloy which is mild steel, stainless steel or brass.

According to a second aspect, the present invention relates to a kit comprising the portable cooking stove of the first aspect of the invention, and one or more solid fuel blocks.

An advantage of the present invention is that any fuel can be used in the stove. This includes pre-packaged solid fuel blocks, liquid fuel burner, for example a Trangia spirit burner or a gas burner. It is also possible to simply use wood or other combustible materials that are readily available in the environment. However, in a preferred embodiment, the present invention makes use of solid fuel blocks. The solid fuel block preferably comprises hexamine, trioxane, or solidified methyl decanoate. Preferably the solid fuel block comprises solidified methyl decanoate.

The present invention also relates to a kit comprising the portable cooking stove of the first aspect of the invention, and a cooking vessel capable of forming an intimate fit with the upper section of the cooking stove.

The cooking vessel can be a saucepan or a round or oval cup but is preferably a kidney shaped military cup, such as the current UK or US standard issue military cups. The UK military cup is shown in FIG. 8.

According to a third aspect, the present invention relates to a method of heating a portable cooking vessel using the cooking stove of the first aspect of the invention, wherein the portable cooking vessel is in intimate contact with the upper section of the cooking stove, a fuel block is inserted into the lower section of the cooking stove, and the fuel block is set alight and allowed to burn.

FIGS. 6 to 8 show a stove (13) according to a preferred embodiment of the present invention. FIG. 6 shows the back of the stove with base (14), lower section (15), and upper section (16). The lower section includes one air inlet port (17). The upper section shows six exhaust ports (18).

FIG. 7 shows that one complete side, in this case, the convex front of the stove is free from inlet or exhaust ports.

FIG. 8 shows the stove containing a cooking vessel which is a 500 ml UK military cup (19). The cup has handles (20). The stove has a corresponding slot cut in the upper section (21) to accommodate the handle of the cup. The lower section (15) of the stove (13) is tapered outwardly. The upper section (16) is not substantially tapered and has approximately parallel walls. The upper section is stepped out from the lower section by providing an indentation in the lower section (22). The stove is made from stainless steel.

### EXAMPLES

The following examples provide details of the performance of a specific embodiment of the present invention, a stove designed to fit a UK military cup, and compares the performance of this embodiment against prior art stoves. The stove of the present invention used in the Examples is that shown in FIGS. 6, 7 and 8 as described above. This is named the EDB stove.

In all the Examples below, the following abbreviations are used:

TTB refers to time to boil
TBT refers to total burn time
Boil refers to the boiling time
The following conditions were measured.
Wind: is given in metres per second (and miles per hour) and was measured using a Testo-410-1 Handheld anemometer.
Air press: refers to air pressure, and is given in kPa. It was measured using a Wall mounted digital barometer—Fischer Scientific.
dew pt. refers to dew point, and is given in degC. It was determined on-line using Acuweather.com; for the location of the experiment, Moncarapacho, PT.
RH: refers to relative humidity, and is given in %. It was measured using Picolog combination digital humidity probe/ambient temp.
amb t: refers to ambient temperature, and is given in degC. It was measured using Picolog combination digital humidity probe/ambient temp.

### Example 1

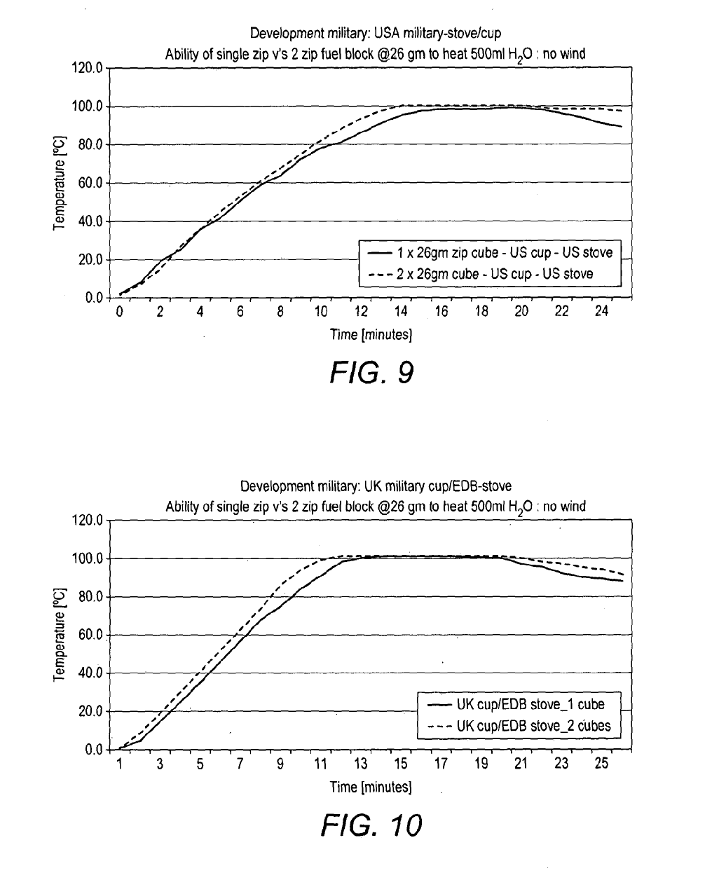

### Comparison of the Current US Stove Using 1 and 2 ZIP Fuel Blocks (FIG. 9) with the Inventive Stove Using 1 and 2 ZIP Fuel Blocks (FIG. 10)

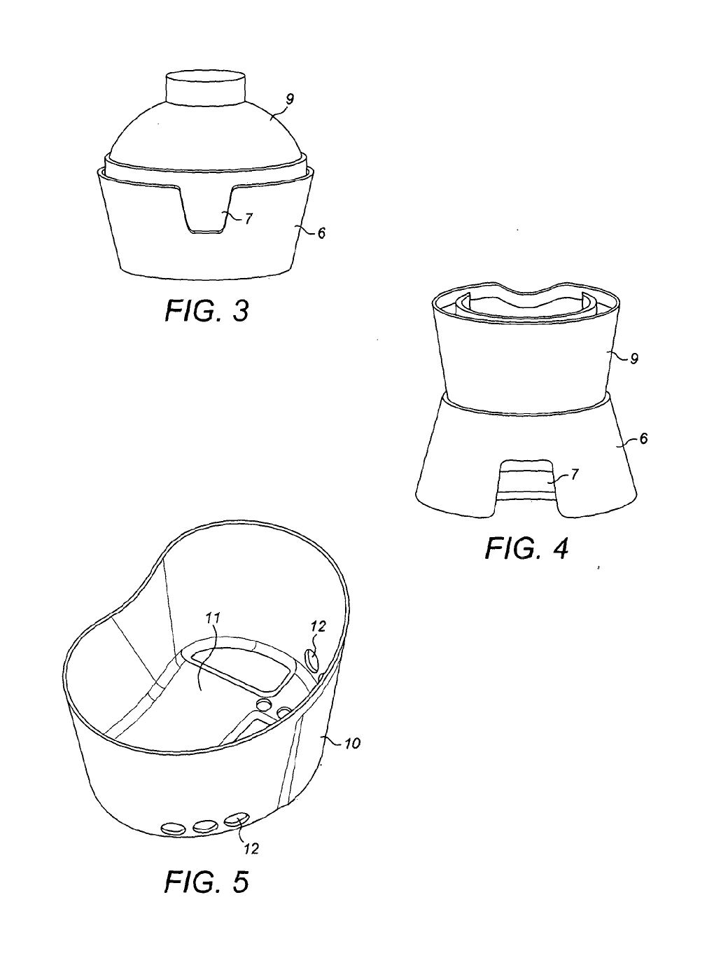

FIG. 9 uses current standard issue US military cup and stove, as shown in FIGS. 3 to 5. Using, as fuel 1× Zip 26 gm block, the results are as follows:

### TTB: 16 min 20 sec

### TBT: 21 min 50 sec

### Boil: 5 min 10 sec

Wind: no wind
Air press: 100.4 kPa
dew pt: 4.2 degC

### RH: 89%

amb t: 5 degC

Using as fuel 2× Zip 26 gm block, the results are as follows:

### TTB: 14 min 5 sec

### TBT: 21 min 20 sec

### Boil: 7 min 5 sec

Wind: no wind
Air press: 100.4 kPa
dew pt: 4.2 degC

### RH: 89%

amb t: 5 degC

FIG. 10 uses the inventive EDB stove with a UK military cup, as shown in FIG. 8. using as fuel 1× Zip 26 gm block, the results are as follows.

### TTB: 12 min 5 sec

### TBT: 20 min 50 sec

### Boil: 8 mM 40 sec

Wind: no wind
Air press: 100.4 kPa
dew pt: 4.2 degC

### RH: 89%

amb t: 5 degC
and using as fuel 2× Zip 26 gm block, the results are as follows.

### TTB: 11 min 15 sec

### TBT: 22 min 10 sec

### Boil: 10 min 5 sec

Wind: no wind
Air press: 100.4 kPa
dew pt: 4.2 degC

### RH: 89%

amb t: 5 degC

A comparison of FIGS. 9 and 10 demonstrates that the EDB stove according to the invention performs significantly better in terms of time taken to boil, and total burn time, than the current US military stove, irrespective of whether one or two ZIP fuel blocks are used.

### Example 2

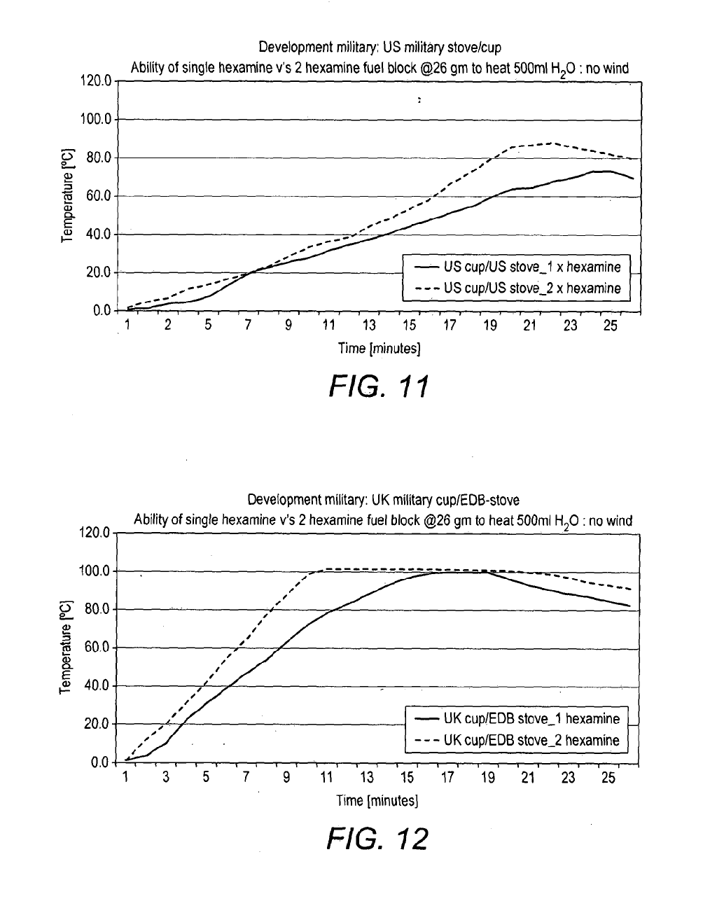

### Comparison of the Current US Stove Using 1 and 2 Hexamine Fuel Blocks (FIG. 11) with the Inventive Stove Using 1 and 2 Hexamine Fuel Blocks (FIG. 12)

FIG. 11 uses current standard issue US military cup and stove, as shown in FIGS. 3 to 5. Using, as fuel 1× Hexamine 26 gm block. The results are as follows.

TTB: failed to boil

### TBT: 25 min 25 sec

Boil: failed to boil
Wind: no wind
Air press: 100.4 kPa
dew pt: 4.2 degC

### RH: 89%

amb t: 5 degC

Using as fuel 2× Hexamine 26 gm block, the results are as follows:

TTB: failed to boil

### TBT: 22 min 50 sec

Boil: failed to boil
Wind: no wind
Air press: 100.4 kPa
dew pt: 4.2 degC

### RH: 89%

amb t: 5 degC

FIG. 12 uses the inventive EDB stove with a UK military cup, as shown in FIG. 8. using as fuel 1× Hexamine 26 gm block, the results are as follows:

### TTB: 16 min 5 sec

### TBT: 19 min 55 sec

### Boil: 3 min 50 sec

Wind: no wind
Air press: 100.4 kPa
dew pt: 4.2 degC

### RH: 89%

amb t: 5 degC

Using as fuel 2× Hexamine 26 gm block, the results are as follows.

### TTB: 11 min 0 sec

### TBT: 22 min 40 sec

### Boil: 11 min 40 sec

Wind: no wind
Air press: 100.4 kPa
dew pt: 4.2 degC

### RH: 89%

amb t: 5 degC

A comparison of FIGS. 11 and 12 demonstrates that the EDB stove according to the invention performs significantly better in terms of time taken to boil, and total burn time, than the current US military stove, irrespective of whether one or two Hexamine fuel blocks are used.

### Example 3

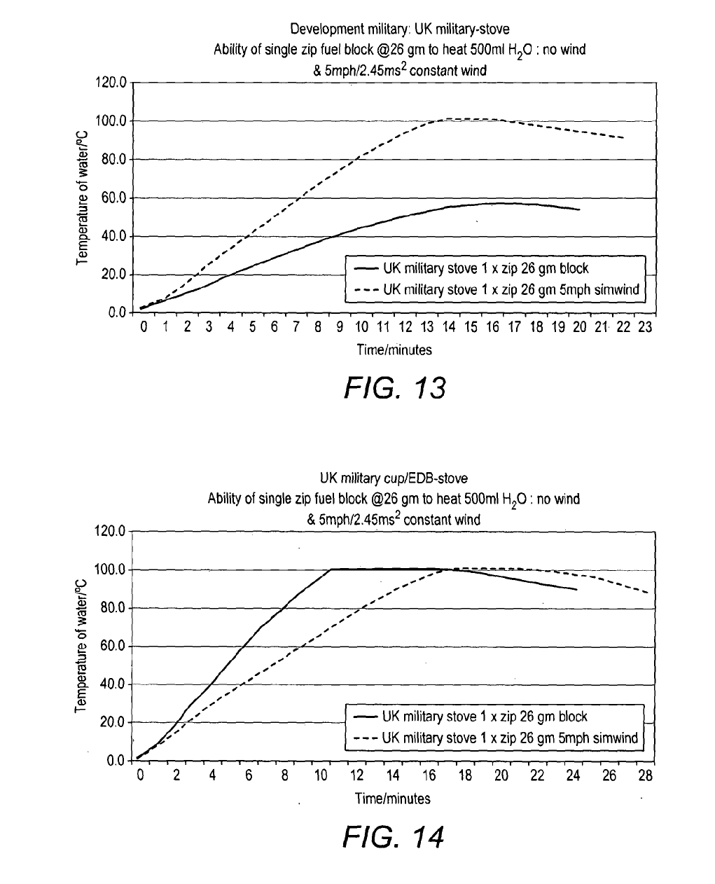

### Comparison of the Current UK Military Stove (FIG. 13) with the EDB Inventive Stove (FIG. 14) Using a 1 ZIP Fuel Block, with and without a Simulated Wind

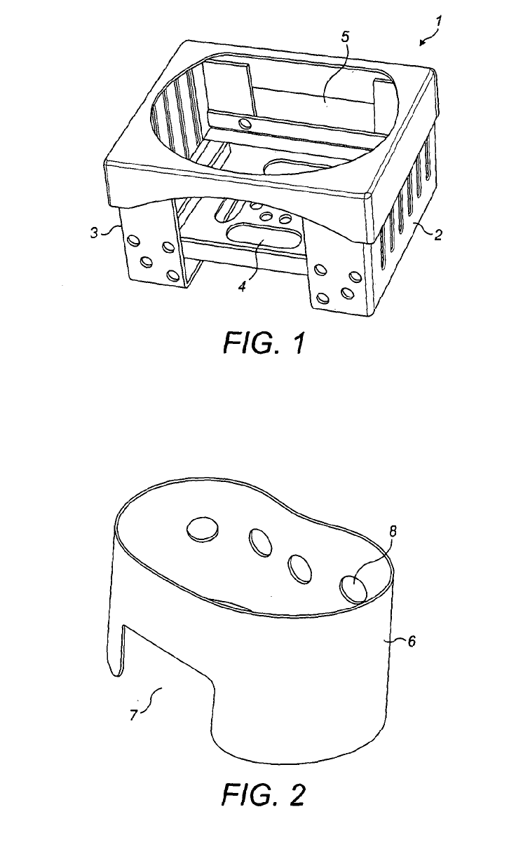

FIG. 13 shows the UK military stove, as shown in FIG. 1, with a single ZIP fuel block as fuel. With no wind, the results are as follows:

### TTB: 12 min 55 sec

### TBT: 16 min 02 sec

### Boil: 3 min 6 sec

Wind: no wind
Air press: 101.96 kPa
dew pt: 13 degC

### RH: 75%

amb t: 16 degC

With a 2.24 ms⁻¹ (5 mph) wind, the results are as follows:

TTB: failed to boil

### TBT: 17 min 10 sec

Boil: failed to boil
Wind: 2.24 ms⁻¹ (5 mph) wind
Air press: 101.96 kPa
dew pt: 13 degC

### RH: 75%

amb t: 16 degC

FIG. 14 shows the EDB stove, as shown in FIGS. 6-8, with a single ZIP fuel block as fuel. With no wind, the results are as follows:

### TTB: 10 min 50 sec

### TBT: 19 min 45 sec

### Boil: 8 min 35 sec

Wind: no wind
Air press: 102.66 kPa
dew pt: 5 degC

### RH: 78%

amb t: 12 degC

With a 2.24 ms⁻¹ (5 mph) wind, the results are as follows:

### TTB: 16 min 43 sec

### TBT: 23 min 45 sec

### Boil: 6 min 57 sec

Wind: 2.24 ms⁻¹ (5 mph) wind
Air press: 102.66 kPa
dew pt: 5 degC

### RH: 78%

amb t: 12 degC

A comparison of FIGS. 13 and 14 demonstrates that the EDB stove according to the invention performs significantly better in terms of time taken to boil, and total burn time, than the current UK military stove, particularly in the presence of wind, where the UK stove performs very badly, without ever reaching boiling.

### Example 4

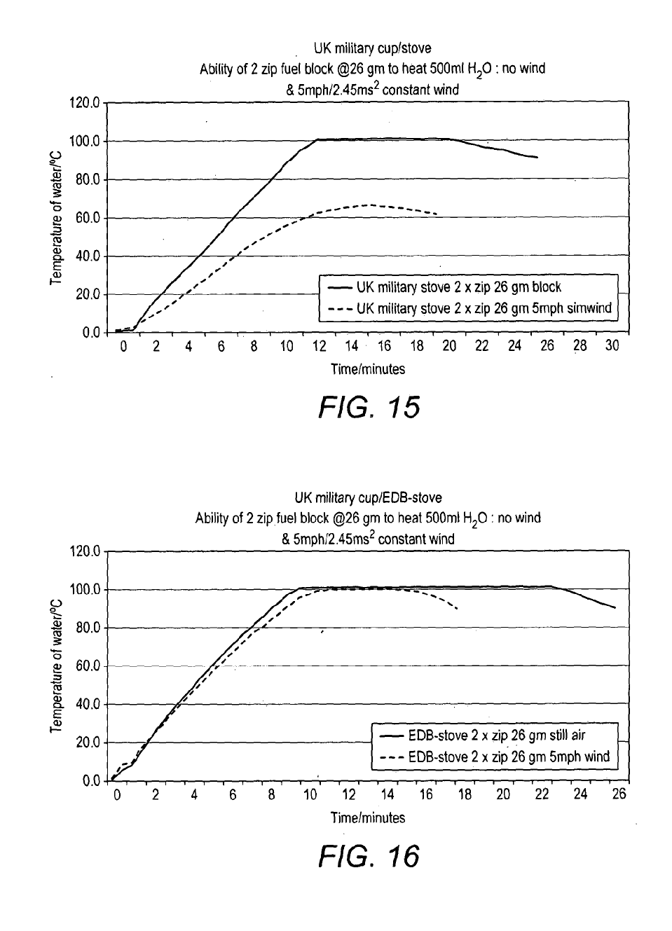

### Comparison of the Current UK Military Stove (FIG. 15) with the EDB Inventive Stove (FIG. 16) Using a 2 ZIP Fuel Blocks, with and without a Simulated Wind

FIG. 15 shows the UK military stove, as shown in FIG. 1, with two ZIP fuel blocks as fuel. With no wind, the results are as follows:

### TTB: 11 min 21 sec

### TBT: 20 min 30 sec

### Boil: 9 min 11 sec

Wind: no wind
Air press: 101.66 kPa
dew pt: 15 degC

### RH: 90%

amb t: 16 degC

With a 2.24 ms⁻¹ (5 mph) wind, the results are as follows:

TTB: no boil:

### TBT: 16 min 23 sec

Boil: no boil
Wind: 2.24 ms⁻¹ (5 mph) wind
Air press: 101.96 kPa
dew pt: 13 degC

### RH: 75%

amb t: 16 degC

FIG. 14 shows the EDB stove, as shown in FIGS. 6-8, with two ZIP fuel blocks as fuel. With no wind, the results are as follows:

### TTB: 10 min 10 sec

### TBT: 23 min 01 sec

### Boil: 12 min 0 sec

Wind: none
Air press: 103.15 kPa
dew pt. 0 degC

### RH: 52%

amb t: 10 degC

With a 2.24 ms⁻¹ (5 mph) wind, the results are as follows:

### TTB: 10 min 35 sec

### TBT: 16 min 50 sec

### Boil: 6 min 15 sec

Wind: 2.24 ms⁻¹ (5 mph) wind
Air press: 102·kPa
dew pt: 14 degC

### RH: 90%

amb t: 12 degC

A comparison of FIGS. 15 and 16 demonstrates that the EDB stove according to the invention performs significantly better in terms of time taken to boil, and total burn time, than the current UK military stove, particularly in the present of wind, where the UK stove performs very badly, without ever reaching boiling.

1. A portable cooking stove comprising:
a base;
a lower section with one or more air inlet ports;
an upper section wherein the upper section and/or the lower section is tapered or the upper section is stepped out from the lower section, so that the upper section defines a larger cross sectional area than the lower section, wherein the upper section has one or more exhaust ports; and
at least one side of the cooking stove is free from air inlet ports and exhaust ports.

2. A portable cooking stove according to claim 1, wherein the ratio of surface area of the exhaust port or ports to the air inlet port or ports is in the range 0.8:1 to 2:1, preferably wherein the range is 1:1 to 1.5:1.

3. A portable cooking stove according to claim 1, wherein there is one air inlet port, preferably wherein the single air inlet port is approximately triangular and is positioned in the lower third of the lower section, with the longest side of the port horizontal to the base.

4. A portable cooking stove according to claim 1, wherein the total surface area of the air inlet port or air inlet ports is 2,000 to 2,250 mm².

5. A portable cooking stove according to claim 1, wherein there are multiple exhaust ports, preferably wherein there are 4-8 exhaust ports, more preferably wherein there are 6 exhaust ports.

6. A portable cooking stove according to claim 1, wherein the total surface area of the exhaust port or exhaust ports is 1,600 to 4,000 mm².

7. A portable cooking stove according to claim 1, wherein the upper section defines substantially a kidney shape.

8. A portable cooking stove according to claim 1, wherein the upper section is shaped to form an intimate fit with a cooking vessel.

9. A portable cooking stove according to claim 8, wherein the lower section tapers outwardly from the base, and the upper section tapers outwardly from the lower section with a smaller taper angle than the lower section, or the upper section is not tapered, preferably where the upper section is not tapered.

10. A portable cooking stove according to claim 1, wherein an indentation is provided in the uppermost part of the lower section, Which is adjacent to the upper section.

11. A portable cooking stove according to claim 1, which is made from metal, preferably wherein the metal is selected from the group consisting of aluminium, titanium, nickel, copper, or an alloy which is mild steel, stainless steel or brass.

12. A portable cooking stove according to claim 1, wherein an additional slot is cut into the upper section of the stove.

13. A kit comprising the portable cooking stove of claim 1 and one or more solid fuel blocks.

14. A kit according to claim 13, wherein the solid fuel block comprises hexamine, trioxane, or solidified methyl decanoate, preferably wherein the solid fuel block comprises solidified methyl decanoate.

15. A kit comprising the portable cooking stove of claim 1 and a cooking vessel which forms an intimate fit with the upper section of the cooking stove, but cannot enter the lower section of the cooking stove.

16. A kit according to claim 15, wherein the cooking vessel is a kidney shaped cup.

17. A method of heating a portable cooking vessel using the cooking stove of claim 1, wherein the portable cooking vessel is in intimate contact with the upper section of the cooking stove, a fuel block is inserted into the lower section of the cooking stove, and the fuel block is set alight and allowed to burn.

18. (canceled)
